(19) United States
(12) Patent Application Publication
(10) Pub. No.: US 2026/0021671 A1
(43) Pub. Date: Jan. 22, 2026

(54) PRINTER

(71) Applicant: FCL COMPONENTS LIMITED, Tokyo (JP)

(72) Inventors: Tatsuya Oguchi, Tokyo (JP); Tetsuhiro Ishikawa, Tokyo (JP); Yuji Yada, Tokyo (JP); Yuuya Ishii, Tokyo (JP); Sota Ishigaki, Tokyo (JP)

(21) Appl. No.: 19/268,123

(22) Filed: Jul. 14, 2025

(30) Foreign Application Priority Data
Jul. 19, 2024 (JP) 2024-115703

(51) Int. Cl. B41J 29/13; B41J 2/32; B41J 11/04; B41J 11/70

(52) U.S. Cl. CPC B41J 29/13; B41J 2/32; B41J 11/04; B41J 11/70

(57) ABSTRACT

A printer according to one embodiment of the present disclosure includes: a printer section configured to print on recording paper; a main body configured to support a first portion of the printer section; an openable-closable section rotatably connected to the main body about a rotary shaft orthogonal to a width direction (Y-axis direction) of the recording paper and configured to support a second portion of the printer section. The printer further includes an opening-closing lever provided at a second end portion of the openable-closable section on a side opposite to a first end portion connected to the main body and configured to rotationally move between a release position, in which the openable-closable section can be opened and closed, and a lock position, in which the openable-closable section is closingly fixed to the main body.

### CROSS-REFERENCE TO RELATED APPLICATION

This application is based upon and claims the benefit of priority of the prior Japanese Patent Application No. 2024-115703 filed on Jul. 19, 2024, the entire contents of which are incorporated herein by reference.

### BACKGROUND

A certain aspect of the embodiments is related to a printer.

Conventionally, thermal printers are known (see, e.g., Japanese Laid-Open Patent Application No. 2012-171114). The thermal printer as described in Japanese Laid-Open Patent Application No. 2012-171114 includes a main body and a cover rotatably supported on the main body.

The cover of the thermal printer as described in Japanese Laid-Open Patent Application No. 2012-171114 is locked to the main body by a lock mechanism connected to an open-close button provided in the main body in normal use. When the open-close button is pressed, the lock mechanism is linked with the movement of the open-close button to release the lock of the cover to the main body. Then, the unlocked cover can be opened to a side by rotating around a central axis of rotation orthogonal to a width direction of paper with respect to the main body.

### SUMMARY

A printer is disclosed including: a printer section configured to print on recording paper; a main body configured to support a first portion of the printer section; an openable-closable section rotatably connected to the main body about a rotary shaft orthogonal to the width direction of the recording paper and configured to support a second portion of the printer section; an opening-closing lever provided at a second end portion of the openable-closable section on a side opposite to a first end portion connected to the main body and configured to rotationally move between a release position in which the openable-closable section can be opened and closed and a lock position in which the openable-closable section is closingly fixed to the main body; and an open-close sensor provided at the main body and configured to detect that the opening-closing lever is in the lock position.

Another aspect of the present disclosure is to provide a printer including: a printer section configured to print on recording paper; a main body configured to support a first portion of the printer section; an openable-closable section rotatably connected to the main body about a rotary shaft orthogonal to a width direction of the recording paper and configured to support a second portion of the printer section; and an opening-closing lever provided at a second end portion of the openable-closable section on a side opposite to a first end portion connected to the main body and configured to rotationally move between a release position in which the openable-closable section can be opened and closed and a lock position in which the openable-closable section is closingly fixed to the main body; and the opening-closing lever includes: an engagement portion that extends along a side surface of the openable-closable section when the opening-closing lever is in the lock position and is configured to engage with a side portion of the main body; and a lock release lever that extends toward the first end portion of the openable-closable section when the opening-closing lever is in the lock position.

### BRIEF DESCRIPTION OF THE DRAWINGS

FIG. 1 is a perspective view illustrating a printer according to a first embodiment;

FIG. 2 is a perspective view illustrating a main body and an openable-closable section;

FIG. 3 is a perspective view illustrating the main body and the openable-closable section;

FIG. 4 is a perspective view illustrating an opening-closing lever;

FIG. 5 is a perspective view illustrating the opening-closing lever;

FIG. 6 is a perspective view illustrating the main body;

FIG. 7 is cross-sectional views illustrating the main body;

FIG. 8 is a perspective view illustrating the main body and the openable-closable section;

FIG. 9 is front views illustrating the main body and the openable-closable section;

FIG. 10 is cross-sectional views illustrating the main body and the openable-closable section;

FIG. 11 is a perspective view illustrating the main body and the openable-closable section according to Modified Example 1;

FIG. 12 is a perspective view illustrating the main body and the openable-closable section according to Modified Example 2;

FIG. 13 is perspective views illustrating the main body and the openable-closable section according to Modified Example 3;

FIG. 14 is cross-sectional views illustrating the main body and the openable-closable section according to a second embodiment; and

FIG. 15 is rear views illustrating a printer according to a comparative example.

### DESCRIPTION OF EMBODIMENTS

An embodiment of the invention will be described in the following with reference to the drawings.

In the thermal printer as described in Japanese Laid-Open Patent Application No. 2012-171114, the lock of the cover to the main body by the lock mechanism is released by pressing the open-close button, but it is not possible to detect a semi-locked state in which the lock of the cover is released when the cover is closed. Therefore, a user of the thermal printer may operate or perform maintenance of the thermal printer without realizing that the thermal printer is in the semi-locked state.

In the thermal printer as described in Japanese Laid-Open Patent Application No. 2012-171114, the opening-closing button is provided on the main body. Therefore, when the thermal printer is disposed in a limited space, it is difficult to press the opening-closing button due to an obstacle around the thermal printer, and there is a possibility that the locking of the cover to the main body by the lock mechanism cannot be released.

Disclosed is a printer capable of detecting a semi-locked state in which an openable-closable section connected to a main body is closed with respect to the main body and the openable-closable section is not fixed to the main body. The present disclosure also provides a printer capable of releasing the locked state of the openable-closable section with respect to the main body even in a limited space.

### First Embodiment

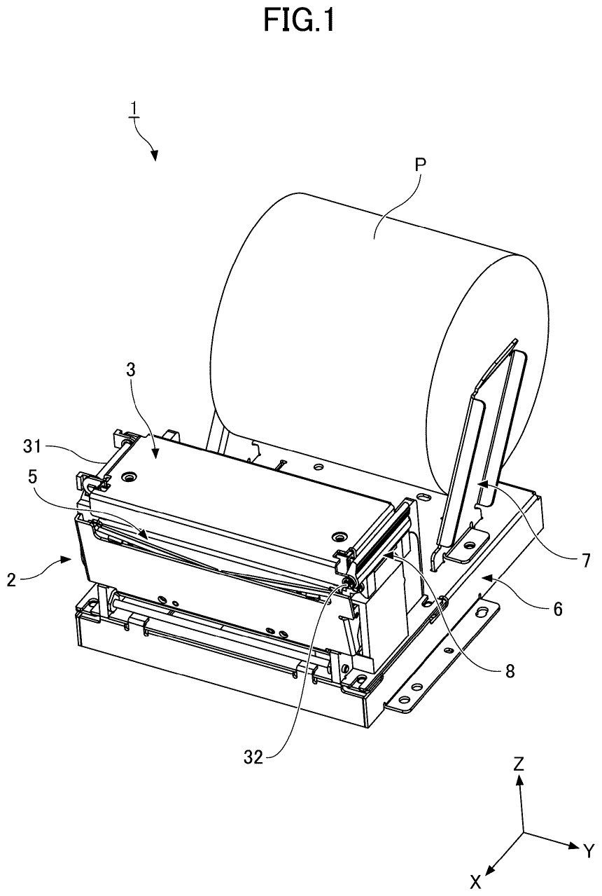

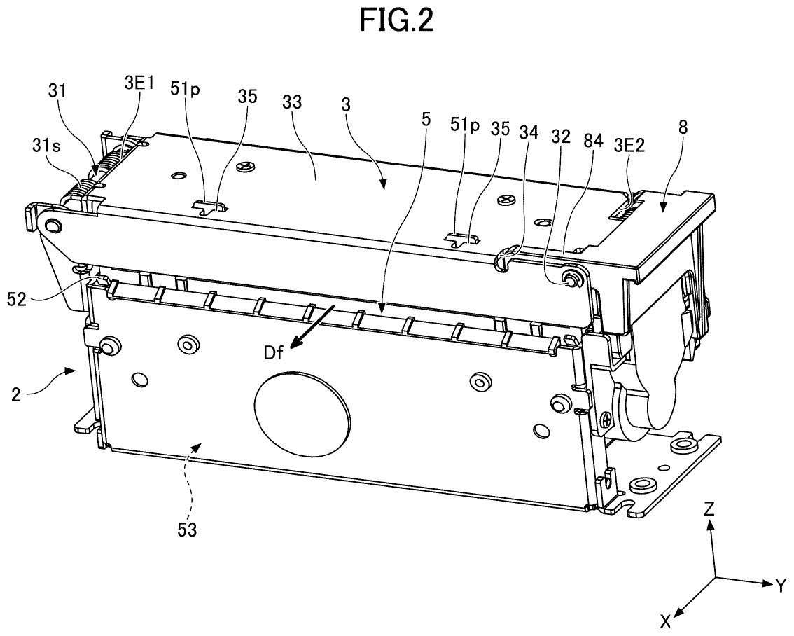

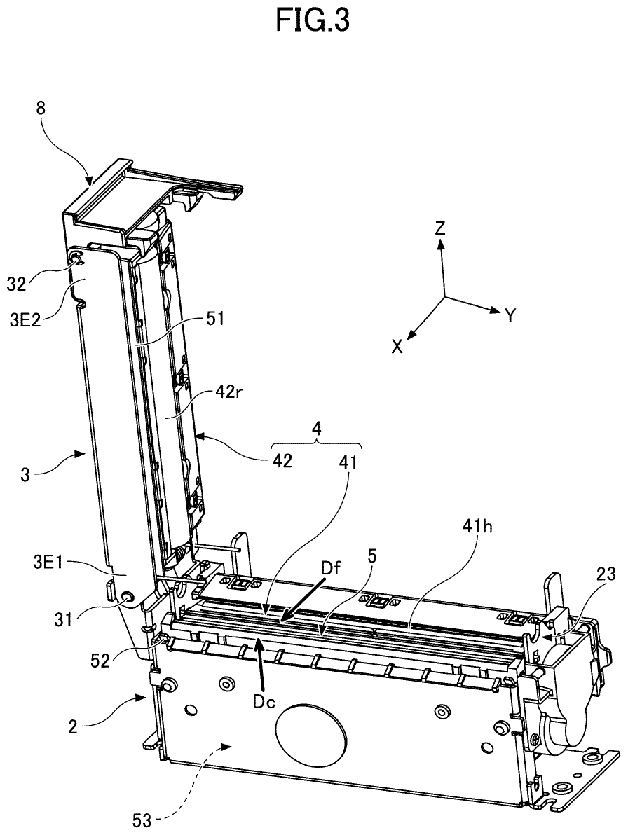

FIG. 1 is a perspective view illustrating a first embodiment of the printer according to the present disclosure. FIGS. 2 and 3 are perspective views illustrating a main body 2 and an openable-closable section 3 of a printer 1 as illustrated in FIG. 1. Each figure is illustrated based on a three-dimensional orthogonal coordinate system in which an X axis is parallel to a conveying direction Df of recording paper P, a Y axis is parallel to the width direction of the recording paper P, and a Z axis is parallel to a cutting direction Dc of the recording paper P.

The printer 1 of the present embodiment is, for example, a thermal printer including a thermal printhead 41h, and is used in a multimedia station (MMS), an automatic teller machine (ATM), an automatic cash dispenser (CD), a ticketing machine, a register installed in a convenience store, or the like. The printer 1 is configured to convey inside thereof, for example, recording paper P, which is thermal paper, and print information such as letters and numerals on the recording paper P, and to cut the recording paper P into pieces to output printed recording paper pieces, such as tickets and receipts.

The printer 1 includes, for example, the main body 2, the openable-closable section 3, a printer section 4, a cutter 5, a base 6, and a recording-paper holder 7. The main body 2 is, for example, a main frame fixed to the base 6, and includes an openable-closable section 3, a printer section 4, a cutter 5, and the like attached to the main body 2.

The openable-closable section 3 is, for example, an openable-closable top portion of the printer 1 disposed above the main body 2 and on a side from which the recording paper is inserted. In FIG. 2, the openable-closable section 3 provided on the upper side of the main body 2 is fully closed, and in FIG. 3, the openable-closable section 3 is fully open. The openable-closable section 3 has, for example, a rectangular planar shape whose longitudinal direction is the width direction of the recording paper P, which is roll paper.

A rotary shaft 31 is provided at a first end portion 3E1 of the openable-closable section 3 in the longitudinal direction. The rotary shaft 31 is inserted into through-holes provided in the main body 2 and is generally parallel to the conveying direction Df (an X-axis direction) of the recording paper P and generally orthogonal to the width direction (a Y-axis direction) and the cutting direction Dc (a Z-axis direction) of the recording paper P. The openable-closable section 3 is connected to the main body 2 to be able to rotate around the rotary shaft 31, and is configured to be openable and closable with respect to the main body 2.

Torsion springs 31s as illustrated in FIG. 2, for example, are disposed around the rotary shaft 31. Each torsion spring 31s includes, for example, a first arm in contact with the main body 2 and a second arm in contact with the openable-closable section 3, and biases the openable-closable section 3 to open with respect to the main body 2 while the openable-closable section 3 is closed with respect to the main body 2. Thus, the openable-closable section 3 can be readily opened from a state that it is closed with respect to the main body 2, and the openable-closable section 3 can be prevented from closing vigorously from a state that it is opened with respect to the main body 2, as illustrated in FIG. 3.

An opening-closing lever 8 is provided at a second end portion 3E2 of the openable-closable section 3 on a side opposite to the first end portion 3E1 connected to the main body 2. The opening-closing lever 8 is rotatably supported, for example, by a rotary shaft 32 provided in the openable-closable section 3. Although details will be described in the following, the opening-closing lever 8 is configured to rotationally move between the release position in which the openable-closable section 3 can be opened/closed and the lock position in which the openable-closable section 3 is closingly fixed to the main body 2. The opening-closing lever 8 also functions, for example, as a grip when the openable-closable section 3 in the closed state as illustrated in FIGS. 1 and 2 is to be opened like the openable-closable section 3 as illustrated in FIG. 3.

Although not illustrated, a torsion spring may be disposed around the rotary shaft 32 in the same manner as the rotary shaft 31. In this case, the torsion spring around the rotary shaft 32 may include a first arm that is in contact with the openable-closable section 3 and a second arm that is in contact with the opening-closing lever 8. Thus, the torsion spring around the rotary shaft 32 biases the opening-closing lever 8 around the rotary shaft 32 such that the opening-closing lever 8 rotationally moves toward the lock position when the opening-closing lever 8 is in an open position, for example.

As illustrated in FIG. 3, the printer section 4 includes a head unit 41 as a first portion for printing on the recording paper P and a platen 42 as a second portion for conveying the recording paper P. In the illustrated example, the head unit 41 is attached to, for example, the main body 2 which is the main frame, and the platen 42 is attached to, for example, the openable-closable section 3. That is, the main body 2 supports the head unit 41 which is the first portion of the printer section 4, and the openable-closable section 3 supports the platen 42 which is the second portion of the printer section 4. The main body 2 is provided with a head frame 23 which supports the head unit 41.

Although not illustrated, the arrangement of the head unit 41 and the platen 42 with respect to the main body 2 and the openable-closable section 3 can be reversed. That is, the main body 2 may support the platen 42 as the first portion of the printer section 4, and the openable-closable section 3 may support the head unit 41 as the second portion of the printer section 4. In this case, a head frame similar to the head frame 23 provided in the main body 2 is provided in the openable-closable section 3 which supports the head unit 41.

The head unit 41 includes, for example, the thermal printhead 41h which is a printhead, and the platen 42 includes a platen roller 42r which conveys the recording paper P.

A conveyance drive system such as a motor and a gear which rotate the platen roller 42r of the platen 42 is attached to the main body 2, for example. In the printer 1, for example, by closing the openable-closable section 3, the gear provided on the platen roller 42r becomes connected to the gear of the conveyance drive system attached to the main body 2. The printer section 4 conveys, for example, the recording paper P inserted between the head unit 41 and the platen 42 to the conveying direction Df by the platen roller 42r, and prints on the recording paper P by the thermal printhead 41h.

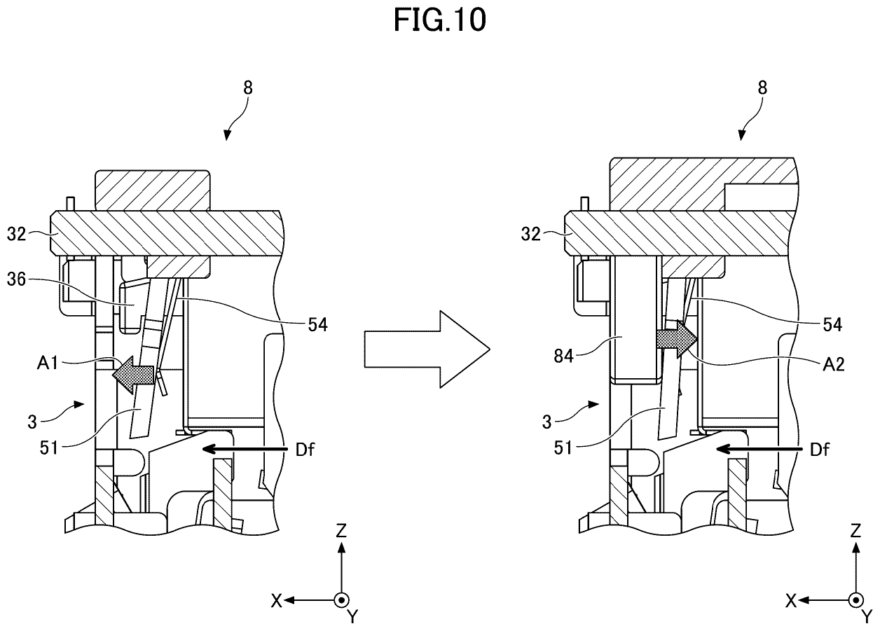

The cutter 5 includes, for example, a fixed blade 51 supported by the openable-closable section 3 and a movable blade 52 disposed adjacent to the fixed blade 51 in the conveying direction Df of the recording paper P and supported by the main body 2. The movable blade 52 is disposed adjacent to the front side of the fixed blade 51 in the conveying direction Df of the recording paper P, for example. The cutter 5 also includes a cutter driver 53 configured to support and vertically move the movable blade 52. Furthermore, although details will be described in the following, the cutter 5 includes, for example, a biasing part 54 (see FIG. 10) configured to bias the fixed blade 51 toward the movable blade 52.

The fixed blade 51 is disposed along the longitudinal direction of the rectangular openable-closable section 3 and is supported by the openable-closable section 3, for example, as illustrated in FIG. 3. The fixed blade 51 has an elongated shape extending in the width direction of the recording paper P. That is, the longitudinal direction of the fixed blade 51 coincides with the longitudinal direction of the openable-closable section 3. The movable blade 52 is supported by the main body 2 by attaching the cutter 5 to the main body 2. The movable blade 52 is provided to be movable in the cutting direction Dc, which is an operational direction generally orthogonal to the conveying direction Df of the recording paper P, by the cutter driver 53.

The cutter driver 53 is always connected to, for example, the motor and the gear. The cutter driver 53 includes, for example, the motor, the gear, a mechanical linkage, etc. attached to the main body 2, and is configured to drive the motor to reciprocatingly move the movable blade 52 in the cutting direction Dc and in an opposite direction. The cutter driver 53, for example, moves the movable blade 52 between a standby position before cutting of the recording paper P starts and a completion position at which the cutting of the recording paper P is completed.

The cutter 5 reciprocates the movable blade 52 in the cutting direction Dc of the recording paper P by the cutter driver 53 while the fixed blade 51 supported by the openable-closable section 3 is biased toward the movable blade 52 by the biasing part 54. Thus, the cutter 5 cuts the recording paper P to which printing is performed by the printer section 4 at a position between the fixed blade 51 and the movable blade 52.

As illustrated in FIG. 1, for example, the base 6 is a rectangular plate member that is configured to serve as a base of the printer 1. On the base 6, the main body 2 and the recording-paper holder 7 are disposed adjacent to each other and are fixed to the base 6. The recording-paper holder 7, for example, rotatably supports the recording paper P, which is roll paper, and continuously supplies the recording paper P between the head unit 41 and the platen 42 of the printer section 4.

As illustrated in FIG. 2, the printer 1 of the present embodiment is characterized in that the lock position of the opening-closing lever 8, which fixes the openable-closable section 3 to the main body 2 in a state where the openable-closable section 3 is closed to the main body 2. Also, as illustrated in FIG. 2, the printer 1 of the present embodiment is characterized in that, in a state where the openable-closable section 3 is closed to the main body 2, the locked state of the openable-closable section 3, in which the opening-closing lever 8 is in the lock position, can be released even when there is not enough space around the openable-closable section 3 for the user to put in the user's hand.

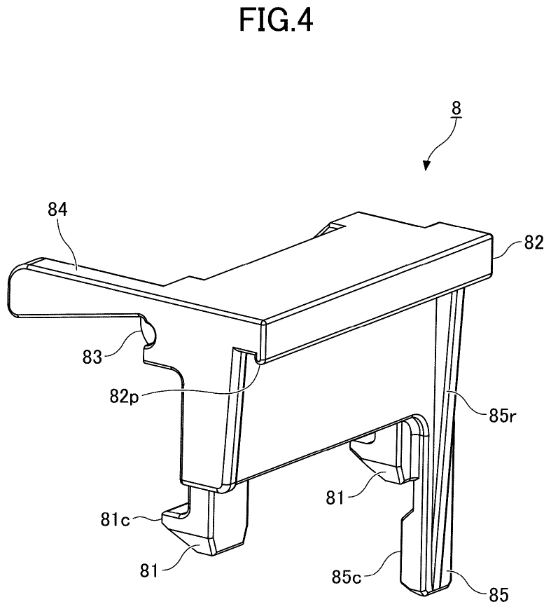

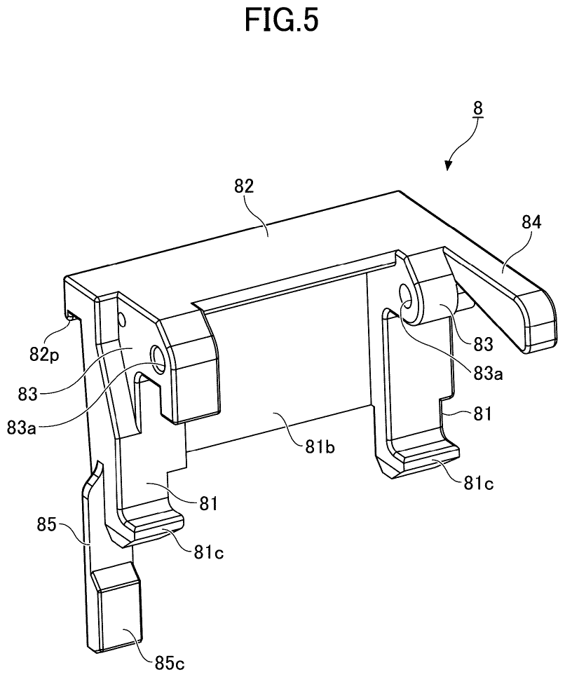

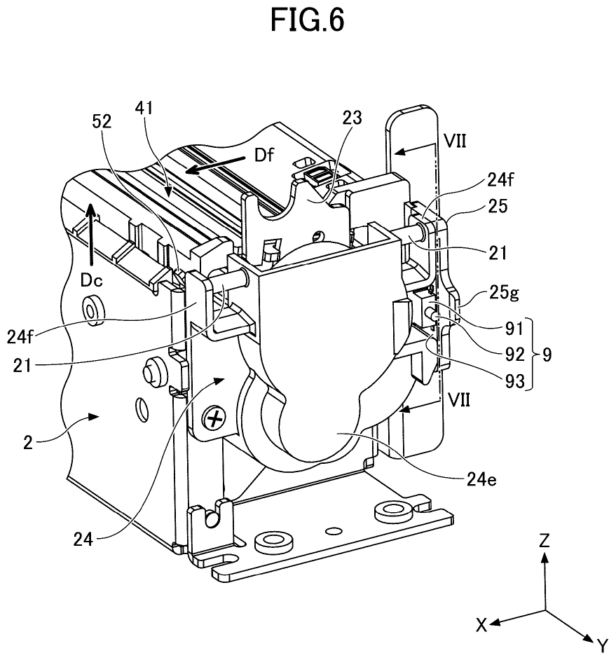

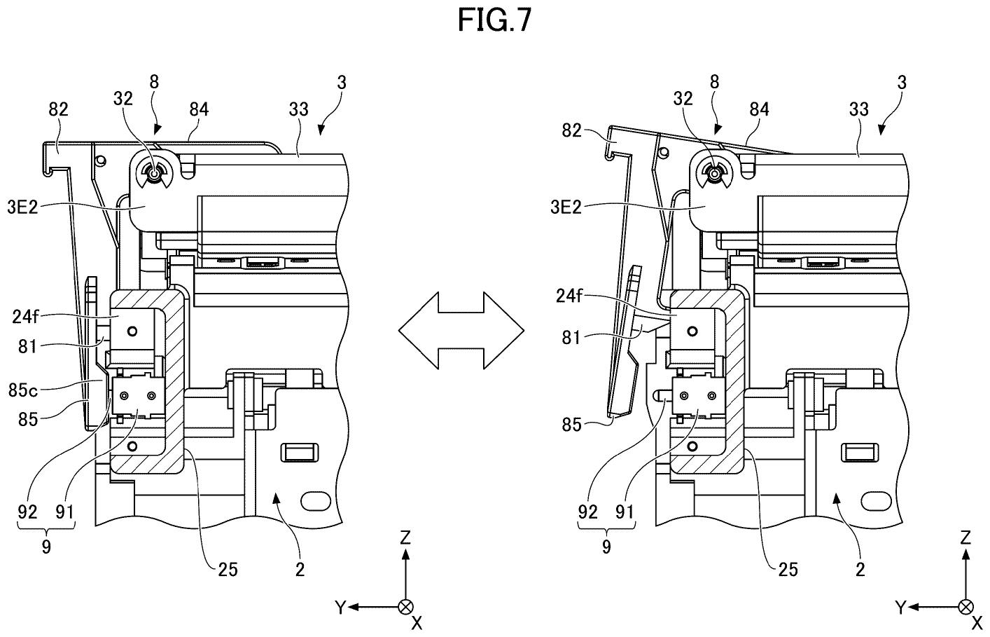

The characteristic configuration of the printer 1 of the present embodiment will be described in detail in the following with reference to FIGS. 4 to 10. FIGS. 4 and 5 are perspective views illustrating the opening-closing lever 8. FIG. 6 is a perspective view illustrating the side of the main body 2 to which the opening-closing lever 8 engages. FIG. 7 is cross-sectional views of the main body 2 taken along a line VII-VII in FIG. 6 illustrating the locked state and the released state of the openable-closable section 3.

As illustrated in FIGS. 4 and 5, the opening-closing lever 8 includes engagement portions 81. The opening-closing lever 8 may also include a grip 82 and shaft supports 83. The opening-closing lever 8 may also include a lock release lever 84 and an extended portion 85. As illustrated in FIGS. 6 and 7, the printer 1 includes an open-close sensor 9 which is provided in the main body 2 and configured to detect that the opening-closing lever 8 is in the lock position.

The engagement portions 81 extend along a side surface of the openable-closable section 3 and engage with a side of the main body 2 when the opening-closing lever 8 is in the lock position as illustrated in the left diagram of FIG. 7. Specifically, as illustrated in FIGS. 2 and 5, for example, the opening-closing lever 8 includes a pair of engagement portions 81 provided at both longitudinal ends of the grip 82 and that extend along a second end portion 3E2 of the openable-closable section 3. The pair of engagement portions 81 are connected by the flat-plate reinforcing portion 81b. Each engagement portion 81 engages with the side of the main body 2, for example, when the opening-closing lever 8 is in the lock position, by hooking hooks 81c provided at tip portions adjacent to the side of the main body 2 to shaft portions 21 provided at the side of the main body 2 as illustrated in FIG. 6.

In the example as illustrated in FIG. 6, each shaft portion 21 for engagement with the hook 81c of the engagement portion 81 of the opening-closing lever 8 is provided between the gear-box body 24e of a gear box 24 provided at the side of the main body 2 and a frame end wall 24f. The gear-box body 24e accommodates, for example, a conveying gear that meshes with a gear of the platen roller 42r of the platen 42 when the openable-closable section 3 is closed to the main body 2. The frame end walls 24f of the gear box 24 project approximately symmetrically from an upper part of the gear box 24 toward a front side and a rear side of the conveying direction Df of the recording paper P, and each of the frame end walls 24f is L-shaped in a side view. Each shaft portion 21 has a cylindrical shape whose center axis is generally parallel to the conveying direction Df of the recording paper P. One end of the shaft portion 21 is connected to the gear-box body 24e, and the other end of the shaft portion 21 is connected to the frame end wall 24f.

As illustrated in FIGS. 2 and 4, the grip 82 is provided at a base end of the engagement portions 81 adjacent to the openable-closable section 3, and projects in a direction away from the side surface of the openable-closable section 3 when the opening-closing lever 8 is in the lock position. When the opening-closing lever 8 is in the lock position, a projecting direction of the grip 82 is a width direction (Y-axis direction) of the recording paper P and is generally orthogonal to a length direction of the engagement portions 81 extending in a cutting direction (Z-axis direction) of the recording paper P. As illustrated in FIGS. 4 and 5, the tip of the grip 82 in the projecting direction is provided with a projection 82p projecting toward the tip side of the engagement portions 81. Thus, when a user of the printer 1 lifts the grip 82 by hand, the user can hook the user's fingers to the projection 82p while holding the grip 82.

As illustrated in FIG. 5, the shaft supports 83 project from the base end of the engagement portions 81 in the direction opposite to the grip 82 and are pivotally supported on the openable-closable section 3. Specifically, the opening-closing lever 8 includes, for example, a pair of shaft supports 83 provided on both longitudinal sides of the grip 82 along the second end portion 3E2 of the openable-closable section 3 as illustrated in FIG. 2. Each shaft support 83 includes a through hole 83a through which the rotary shaft 32 provided on the second end portion 3E2 of the openable-closable section 3 can be inserted. The pair of shaft supports 83 are pivotally supported on the openable-closable section 3 by, for example, inserting the rotary shaft 32 provided on the openable-closable section 3 through the through hole 83a provided on each shaft support 83.

As illustrated in FIG. 2, the lock release lever 84 extends toward the first end portion 3E1 of the openable-closable section 3 when the opening-closing lever 8 is in the lock position. The lock release lever 84 extends, for example, along the upper surface of the openable-closable section 3, which is the end surface of the openable-closable section 3 on a side opposite to the main body 2. Specifically, when the opening-closing lever 8 is in the lock position, the lock release lever 84 extends along the upper surface of a cover 33 of the openable-closable section 3 from the second end portion 3E2 to the first end portion 3E1.

In the example as illustrated in FIG. 2, the cover 33 of the openable-closable section 3 includes a notch 34 that is shaped along the outer shape of the lock release lever 84. The lock release lever 84 is accommodated in the notch 34 provided in the cover 33 of the openable-closable section 3 when the opening-closing lever 8 is in the lock position, and extends along the upper surface of the cover 33 in the width direction (Y-axis direction) of the recording paper P. In the example as illustrated in FIG. 2 and in the left diagram of FIG. 7, when the opening-closing lever 8 is in the lock position, at least a part of the lock release lever 84 projects from the end surface of the openable-closable section 3 on the side opposite to the main body 2.

Specifically, in the example as illustrated in FIG. 2 and in the left diagram of FIG. 7, a part of the lock release lever 84 projects from the upper surface of the openable-closable section 3, which is the end surface of the openable-closable section 3 on the side opposite to the main body 2. Specifically, when the opening-closing lever 8 is in the lock position, one end of the lock release lever 84 in the cutting direction Dc (Z-axis direction) of the recording paper P projects upward (outside of the cover 33) from the upper surface of the cover 33 of the openable-closable section 3 from the base end to the tip of the lock release lever 84 extending in the width direction (Y-axis direction) of the recording paper P.

As illustrated in the left diagram of FIG. 7, when the opening-closing lever 8 is in the lock position, the extended portion 85 extends along the side surface of the openable-closable section 3 and along the main body 2 to a position farther away from the openable-closable section 3 as compared to the engagement portion 81. As illustrated in FIGS. 4 and 5, the extended portion 85 includes a projecting portion 85c at its tip. When the opening-closing lever 8 is in the lock position as illustrated in the left diagram of FIG. 7, the projecting portion 85c is provided to project further toward the side of the main body 2 as compared to other portions of the extended portion 85. The top surface of the projecting portion 85c facing the side of the main body 2 when the opening-closing lever 8 is in the lock position is a plane generally perpendicular to the width direction (Y-axis direction) of the recording paper P.

Furthermore, as illustrated in FIG. 4, for example, the extended portion 85 includes a rib 85r projecting in the direction opposite to the projecting portion 85c from the surface opposite to the surface on which the projecting portion 85c is provided. The rib 85r extends, for example, from the proximal end of the extended portion 85 connected to the grip 82 to the distal end of the extended portion 85. The height of the rib 85r in the projecting direction increases as it approaches the proximal end of the extended portion 85. The rib 85r enhances the rigidity of the extended portion 85 against the force in the projecting direction of the rib 85r acting on the projecting portion 85c at the distal end of the extended portion 85.

In the example as illustrated in FIG. 6, the open-close sensor 9 configured to detect the lock position of the opening-closing lever 8 is mounted on a circuit board 93 and attached to a support plate 25 on the side of the main body 2. The support plate 25 is, for example, a plate-like member substantially parallel to the width direction (Y-axis direction) and the cutting direction Dc (Z-axis direction) of the recording paper P, and is attached to the side wall of the main body 2. The circuit board 93 is attached to be sandwiched between the frame end wall 24f of the gear box 24 and the support plate 25.

The open-close sensor 9 detects, for example, that the opening-closing lever 8 is in the lock position, according to the position of the side surface of the extended portion 85 facing the main body 2. Specifically, the open-close sensor 9 includes, for example, a plunger 92 configured to detect that the opening-closing lever 8 is in the lock position by being pushed in by the opening-closing lever 8 in the lock position, as illustrated in the left diagram of FIG. 7. The plunger 92 projects toward the side surface of the extended portion 85 facing the main body 2, for example, when the opening-closing lever 8 is in the lock position.

More specifically, the open-close sensor 9 includes, for example, a main body 91 having a generally rectangular parallelepiped shape and the plunger 92 which projects outward in the width direction of the recording paper P from the main body 91, as illustrated in FIG. 6. The main body 91 is mounted on the circuit board 93. The plunger 92 is biased outward in the width direction of the recording paper P by, for example, a spring in the main body 91, and pushed into the main body 91 to open a switch connected to an electronic circuit of the circuit board 93. The circuit board 93 includes, for example, an electronic circuit which detects that the opening-closing lever 8 is in the lock position when the switch is opened by the plunger 92.

As illustrated in FIG. 6, for example, the support plate 25 includes a guide portion 25g projecting outward in the width direction (Y-axis direction) of the recording paper P, at the center of the cutting direction Dc (Z-axis direction) of the recording paper P. The surface of the guide portion 25g facing the open-close sensor 9 is inclined such that the outer side in the width direction of the recording paper P is farther away from the open-close sensor 9. As a result, the guide portion 25g guides the extended portion 85 such that the plunger 92 of the open-close sensor 9 can be securely pressed by the extended portion 85 when the opening-closing lever 8 is rotationally moved from the release position to the lock position, such that the plunger 92 faces the end surface of the projecting main body 91.

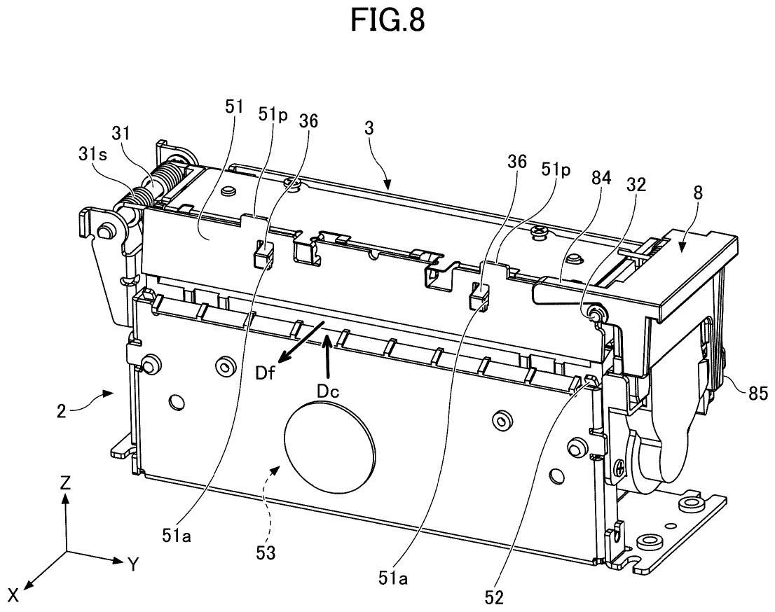

In addition, in the printer 1 of the present embodiment, the opening-closing lever 8 has a function of eliminating paper jam. Paper jam is a defect in which the recording paper P is caught between the fixed blade 51 and the movable blade 52 when the recording paper P is cut by the cutter 5, and the movable blade 52 cannot be operated. The function of eliminating paper jam by the opening-closing lever 8 of the printer 1 of the present embodiment will be described in the following with reference to FIGS. 8 to 10.

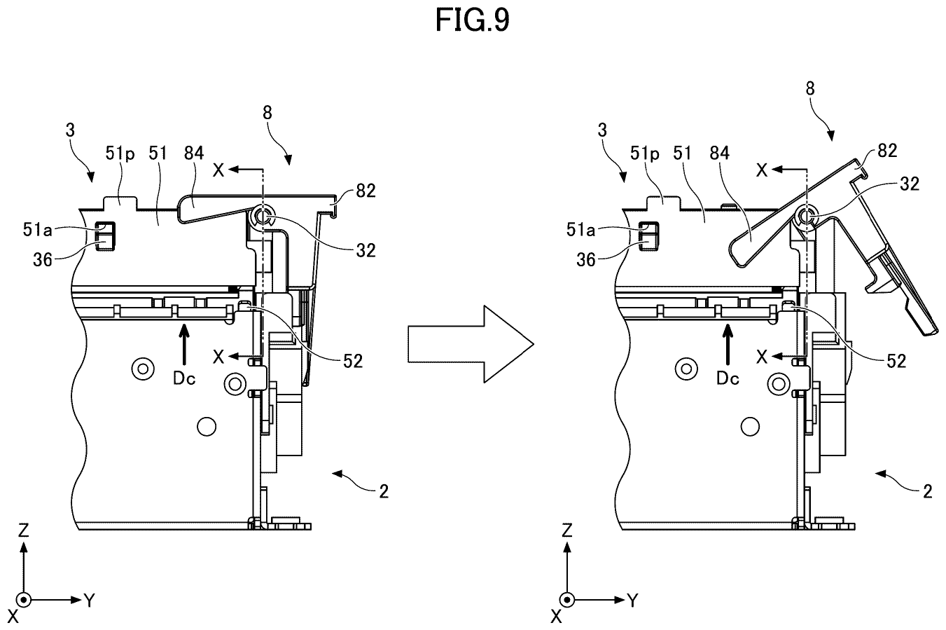

FIG. 8 is a perspective view illustrating the main body 2 and the openable-closable section 3 with the cover 33 of the openable-closable section 3 removed. FIG. 9 is front views illustrating the main body 2 and the openable-closable section 3 in the vicinity of the opening-closing lever 8 illustrating the operation of the opening-closing lever 8. FIG. 10 is cross-sectional views illustrating the main body 2 and the openable-closable section 3 taken along a line X-X of FIG. 9.

In the printer 1 of the present embodiment, the fixed blade 51 of the cutter 5 is swingably supported by the openable-closable section 3. Specifically, as illustrated in FIG. 8, the fixed blade 51 includes tongue-shaped projections 51p at the end edge along the longitudinal direction facing the movable blade 52 in the cutting direction Dc (Z-axis direction) of the recording paper P. The fixed blade 51 includes, for example, a pair of projections 51p between both ends and a central portion in the longitudinal direction.

The projections 51p of the fixed blade 51 are inserted into through holes 35 provided in the cover 33 of the openable-closable section 3, as illustrated in FIG. 2. A space is formed between the through holes 35 of the openable-closable section 3 and the projections 51p of the fixed blade 51 in the conveying direction Df of the recording paper P. As illustrated in FIG. 8, the fixed blade 51 includes through holes 51a in the vicinity of the projections 51p. Projections 36 of the openable-closable section 3 are inserted into the through holes 51a of the fixed blade 51. The projections 36 are provided in the openable-closable section 3 and project forward in the conveying direction Df of the recording paper P. A space is formed between the through holes 51a of the fixed blade 51 and the projections 36 of the openable-closable section 3 in the cutting direction Dc of the recording paper P.

Also, as illustrated in the left diagram of FIG. 10, the cutter 5 includes the biasing part 54 configured to bias the fixed blade 51 in the direction of arrow A1 toward the movable blade 52. The biasing part 54 is, for example, a leaf spring fixed to the openable-closable section 3. The movable blade 52 is disposed further on the front side as compared to the fixed blade 51 in the conveying direction Df of the recording paper P. As described above, the projections 51p of the fixed blade 51 are inserted into the through holes 35 of the openable-closable section 3, and the projections 36 of the openable-closable section 3 are inserted into the through holes 51a, and are biased toward the front side of the conveying direction Df of the recording paper P by the biasing part 54.

With this configuration, the fixed blade 51 is swingably supported by the openable-closable section 3. As illustrated in the left diagram of FIG. 10, the fixed blade 51 is biased toward the front of the conveying direction Df of the recording paper P by the biasing part 54 when no force is applied toward the rear of the conveying direction Df of the recording paper P, and is disposed at a steady position in which the recording paper P can be cut. In contrast to this, when a force greater than the biasing force of the biasing part 54 acts toward the rear of the conveying direction Df of the recording paper P, the tip of the fixed blade 51 swings toward the rear of the conveying direction Df of the recording paper P with the through holes 35 of the openable-closable section 3 as the fulcrum, as illustrated in FIG. 2 and the right diagram of FIG. 10.

As illustrated in the left diagram of FIG. 9 and the left diagram of FIG. 10, when the opening-closing lever 8 is in the lock position, the lock release lever 84 is disposed at a steady position on the side of the biasing direction of the biasing part 54 (the direction of arrow A1 in the left diagram of FIG. 10) relative to the fixed blade 51. In other words, as illustrated in FIG. 8 and the left diagram of FIG. 9, when the opening-closing lever 8 is in the lock position, the lock release lever 84 is disposed at a steady position further on the front side in the conveying direction Df of the recording paper P relative to the fixed blade 51. In this steady position, the lock release lever 84 is located, for example, on the upper side in front of the fixed blade 51 as illustrated in the left diagram of FIG. 10, and is not in contact with the fixed blade 51. In contrast to this, when the opening-closing lever 8 is rotationally moved from the lock position to the release position, the lock release lever 84 is rotationally moved toward the movable blade 52 in the cutting direction Dc of the recording paper P and is disposed at a paper release position, as illustrated in the right diagram of FIG. 9 and the right diagram of FIG. 10.

In the paper release position as illustrated in the right diagram of FIG. 10, the lock release lever 84 swings the fixed blade 51 against the biasing force of the biasing part 54 to push it in the direction of arrow A2, and separates the tip of the fixed blade 51 from the movable blade 52. Here, the direction of arrow A2 in which the lock release lever 84 separates the fixed blade 51 from the movable blade 52 is opposite to the direction of arrow A1, which is the biasing direction of the biasing part 54 as illustrated in the left diagram of FIG. 10. As described above, in the release position of the opening-closing lever 8 as illustrated in the right diagram of FIG. 9 and the right diagram of FIG. 10, the lock release lever 84 is disposed in the paper release position in which the fixed blade 51 is separated from the movable blade 52 in the direction opposite to the biasing direction of the biasing part 54.

Hereinafter, the operation of the printer 1 of the present embodiment will be described based on the comparison with the printer of a comparative example different from the printer according to the present disclosure.

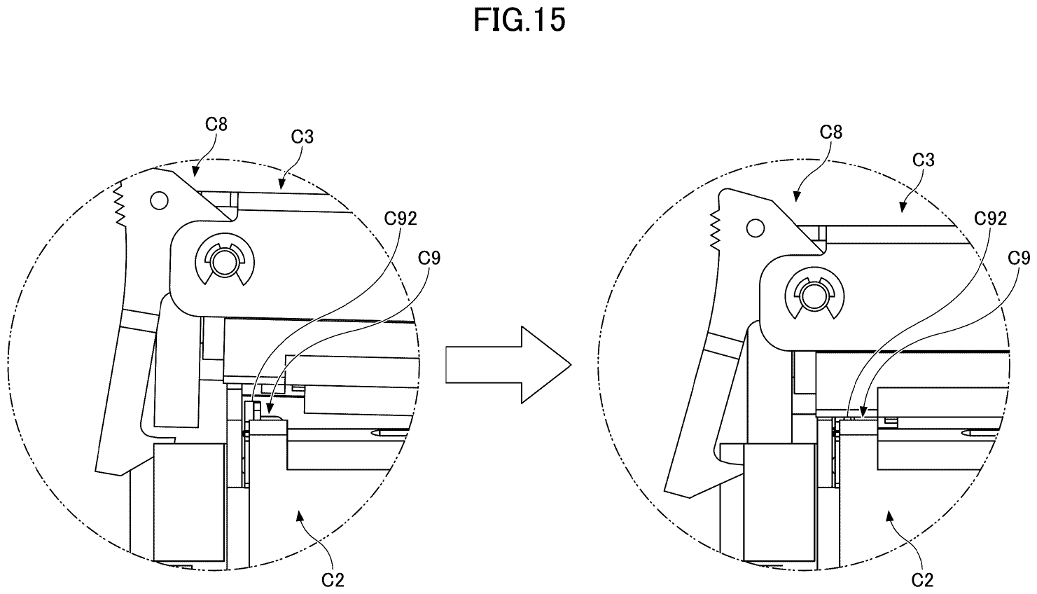

FIG. 15 is enlarged rear views illustrating a part of a main body C2 and an openable-closable section C3 of the printer of the comparative example. The printer of the comparative example is different from the printer 1 of the present embodiment mainly in that an open-close sensor C9 is provided at the upper end of the main body C2 facing the openable-closable section C3, and an opening-closing lever C8 does not include the lock release lever 84 and the extended portion 85. Other configurations of the printer of the comparative example are the same as those of the printer 1 of the present embodiment.

As illustrated in the left diagram of FIG. 15, the open-close sensor C9 of the printer of the comparative example detects that the openable-closable section C3 is open when the openable-closable section C3 is not closed to the main body C2 and a plunger C92 of the open-close sensor C9 is not pushed in. As illustrated in the right diagram of FIG. 15, the open-close sensor C9 of the printer of the comparative example detects that the openable-closable section C3 is closed when the openable-closable section C3 is closed to the main body C2 and the plunger C92 of the open-close sensor C9 is pushed in by the openable-closable section C3. However, the open-close sensor C9 of the printer of the comparative example cannot detect a semi-locked state in which the opening-closing lever C8 is not engaged with the side of the main body C2.

In contrast to this, the printer 1 of the present embodiment includes the printer section 4, the main body 2, the openable-closable section 3, the opening-closing lever 8, and the open-close sensor 9 as described above. The printer section 4 prints information such as characters and numerals on the recording paper P. The main body 2 supports the head unit 41 as the first portion of the printer section 4. The openable-closable section 3 is rotatably connected to the main body 2 about the rotary shaft 31 orthogonal to the width direction of the recording paper P, and supports the platen 42 as the second portion of the printer section 4. The opening-closing lever 8 is provided on the second end portion 3E2 of the openable-closable section 3 on a side opposite to the first end portion 3E1 connected to the main body 2, and is configured to rotationally move between the release position in which the openable-closable section 3 can be opened and closed and the lock position in which the openable-closable section 3 is closingly fixed to the main body 2. The open-close sensor 9 is provided on the main body 2, and detects that the opening-closing lever 8 is in the lock position.

With this configuration, the openable-closable section 3 can be closingly fixed to the main body 2 by closing the openable-closable section 3 relative to the main body 2 as illustrated in FIG. 2 from the state the openable-closable section 3 is open relative to the main body 2 as illustrated in FIG. 3, and rotationally moving the opening-closing lever 8 from the release position to the lock position. At this time, the open-close sensor 9 detects that the opening-closing lever 8 is in the lock position by rotationally moving the opening-closing lever 8 in the release position, as illustrated in the right diagram of FIG. 7, to the lock position, as illustrated in the left diagram of FIG. 7, with the openable-closable section 3 closed to the main body 2. In other words, in the semi-locked state where the opening-closing lever 8 is not in the lock position with the openable-closable section 3 closed to the main body 2, the open-close sensor 9 detects that the opening-closing lever 8 is in the release position. Therefore, according to the printer 1 of the present embodiment, the semi-locked state where the openable-closable section 3 is closed to the main body 2 and the openable-closable section 3 is not fixed to the main body 2 can be detected based on a detection result of the open-close sensor 9.

Moreover, in the printer 1 of the present embodiment, the open-close sensor 9 includes the plunger 92 which detects the lock position of the opening-closing lever 8 by being pushed by the opening-closing lever 8 in the lock position. With this configuration, it is possible to detect that the opening-closing lever 8 is in the lock position by using the simple plunger-type open-close sensor 9. Therefore, the component cost of the printer 1 can be suppressed and the structure of the printer 1 can be simplified.

In the printer 1 of the present embodiment, the opening-closing lever 8 includes the engagement portions 81 and the extended portion 85. The engagement portions 81 extend along the side surface of the openable-closable section 3 when the opening-closing lever 8 is in the lock position and engage with the side surface of the main body 2. The extended portion 85 extends along the side surface of the openable-closable section 3 to a position further distant from the openable-closable section 3 as compared to the engagement portions 81 when the opening-closing lever 8 is in the lock position. The open-close sensor 9 detects that the opening-closing lever 8 is in the lock position according to the position of the side surface of the extended portion 85 facing the main body 2.

With this configuration, erroneous detection of the open-close sensor 9, that is, the open-close sensor 9 detecting that the opening-closing lever 8 is in the lock position before the engagement portions 81 of the opening-closing lever 8 engage with the side surface of the main body 2, can be prevented. More specifically, when the opening-closing lever 8 is in the lock position as illustrated in the left diagram of FIG. 7, the extended portion 85 extends along the side surface of the openable-closable section 3 and the side surface of the main body 2 to a position further distant from the openable-closable section 3 as compared to the engagement portions 81. Therefore, at or after the time when the opening-closing lever 8 is rotationally moved to the lock position and the engagement portions 81 are engaged with the side portion of the main body 2, the open-close sensor 9 detects that the opening-closing lever 8 is in the lock position according to the position of the side surface of the extended portion 85. Thus, the open-close sensor 9 can further reliably detect that the opening-closing lever 8 is in the lock position. Therefore, according to the printer 1 of the present embodiment, as illustrated in the right diagram of FIG. 7, the semi-locked state of the openable-closable section 3, in which the openable-closable section 3 is closed to the main body 2 and the opening-closing lever 8 is in the release position, can be further reliably detected.

More specifically, the plunger 92 of the open-close sensor 9 projects toward the side surface of the extended portion 85 facing the main body 2 when the opening-closing lever 8 is in the lock position. This prevents the plunger 92 of the open-close sensor 9 from being pushed in before the engagement portions 81 of the opening-closing lever 8 engage with the side surface of the main body 2. More specifically, when the opening-closing lever 8 is in the lock position as illustrated in the left diagram of FIG. 7, the extended portion 85 extends along the side surface of the openable-closable section 3 and the side surface of the main body 2 to a position farther away from the openable-closable section 3 as compared to the engagement portions 81. Therefore, at or after the time when the opening-closing lever 8 is rotationally moved to the lock position and the engagement portions 81 are engaged with the side surface of the main body 2, the plunger 92 of the open-close sensor 9 can be pushed in to the end by the extended portion 85. Thus, the open-close sensor 9 can further reliably detect that the opening-closing lever 8 is in the lock position. Therefore, according to the printer 1 of the present embodiment, as illustrated in the right diagram of FIG. 7, the semi-locked state of the openable-closable section 3, in which the openable-closable section 3 is closed to the main body 2 and the opening-closing lever 8 is in the release position, can be further reliably detected.

Moreover, the opening-closing lever 8 of the printer 1 of the present embodiment includes the lock release lever 84 extending toward the first end portion 3E1 of the openable-closable section 3 when the opening-closing lever 8 is in the lock position.

With this configuration, for example, even when the printer 1 is housed in the housing and there is not enough space around the opening-closing lever 8 for the user of the printer 1 to put in the user's hand, the opening-closing lever 8 can be rotationally moved from the lock position to the release position by pushing the lock release lever 84 toward the main body 2. Specifically, by pushing the lock release lever 84 of the opening-closing lever 8 in the lock position as illustrated in the left diagram of FIG. 7 toward the main body 2, the opening-closing lever 8 rotationally moves from the lock position to the release position, as illustrated in the right diagram of FIG. 7, and the openable-closable section 3 can be opened relative to the main body 2.

Also, in the opening-closing lever 8 of the printer 1 of the present embodiment, at least a part of the lock release lever 84 projects from the end surface of the openable-closable section 3 on the side opposite to the main body 2 when the opening-closing lever 8 is in the lock position.

With this configuration, the user of the printer 1 can visually understand that the opening-closing lever 8 rotationally moves from the lock position to the release position by pushing the lock release lever 84 toward the main body 2. In addition, the user of the printer 1 can rotationally move, further readily, the opening-closing lever 8 from the lock position to the release position by pushing the lock release lever 84 projected from the end surface of the openable-closable section 3 on the side opposite to the main body 2 toward the main body 2.

In the printer 1 of the present embodiment, the lock release lever 84 of the opening-closing lever 8 is disposed at the front end of the openable-closable section 3 in the conveying direction Df of the recording paper P, but may be disposed at the rear end of the openable-closable section 3 in the conveying direction Df of the recording paper P. With this configuration, the degree of freedom in the design of the printer 1 can be enhanced.

The printer 1 of the present embodiment further includes the cutter 5 configured to cut recording paper P. The cutter 5 includes the fixed blade 51 supported by the openable-closable section 3, the movable blade 52 disposed adjacent to the fixed blade 51 in the conveying direction Df of the recording paper P and supported by the main body 2, and the biasing part 54 configured to bias the fixed blade 51 toward the movable blade 52. The lock release lever 84 of the opening-closing lever 8 is disposed at a steady position farther on a biasing direction side of the biasing part 54 relative to the fixed blade 51 when the opening-closing lever 8 is in the lock position. The lock release lever 84 of the opening-closing lever 8 is disposed at the paper release position, in which the fixed blade 51 is separated from the movable blade 52 in a direction opposite to the biasing direction of the biasing part 54, when the opening-closing lever 8 is in the release position.

With this configuration, the lock release lever 84 can separate the fixed blade 51 from the movable blade 52 as illustrated in FIG. 10 by moving the opening-closing lever 8 from the lock position to the release position as illustrated in FIG. 9. Thus, when a paper jam in which the recording paper P is caught between the fixed blade 51 and the movable blade 52 occurs and the movable blade 52 cannot be operated, the paper jam can be eliminated by moving the opening-closing lever 8 from the lock position to the release position to separate the fixed blade 51 from the movable blade 52.

The printer 1 of the present embodiment includes the printer section 4, the main body 2, the openable-closable section 3, and the opening-closing lever 8. The printer section 4 prints information such as characters and numerals on the recording paper P. The main body 2 supports the head unit 41 as the first portion of the printer section 4. The openable-closable section 3 is rotatably connected to the main body 2 around the rotary shaft 31 orthogonal to the width direction of the recording paper P, and configured to support the platen 42 as the second portion of the printer section 4. The opening-closing lever 8 is provided at the second end portion 3E2 of the openable-closable section 3 on the side opposite to a first end portion 3E1 connected to the main body 2, and is configured to rotationally move between the release position in which the openable-closable section 3 can be opened and closed and the lock position in which the openable-closable section 3 is closingly fixed to the main body 2. The opening-closing lever 8 includes the engagement portions 81 extending along the side of the openable-closable section 3 and engaging with the side of the main body 2 when the opening-closing lever 8 is in the lock position, and the lock release lever 84 extending toward the first end portion 3E1 of the openable-closable section 3 when the opening-closing lever 8 is in the lock position.

With this configuration, for example, even when the printer 1 is housed in a housing and there is not enough space around the opening-closing lever 8 for the user of the printer 1 to put in the user's hand, it is possible to push the lock release lever 84 toward the main body 2 and rotationally move the opening-closing lever 8 from the lock position to the release position. Specifically, by pushing the lock release lever 84 of the opening-closing lever 8 in the lock position as illustrated in the left diagram of FIG. 7 toward the main body 2, the opening-closing lever 8 rotationally moves from the lock position to the release position, and the openable-closable section 3 can be opened relative to the main body 2, as illustrated in the right diagram of FIG. 7. Therefore, according to the printer 1 of the present embodiment, it is possible to release the locked state of the openable-closable section 3 relative to the main body 2 even in a limited space.

As described above, according to the present embodiment, it is possible to provide the printer 1 configured to detect the semi-locked state, in which the openable-closable section 3 connected to the main body 2 is closed to the main body 2 and the openable-closable section 3 is not fixed to the main body 2. Furthermore, according to the present embodiment, it is possible to provide a printer 1 capable of releasing the locked state of the openable-closable section 3 to the main body 2 even in a limited space.

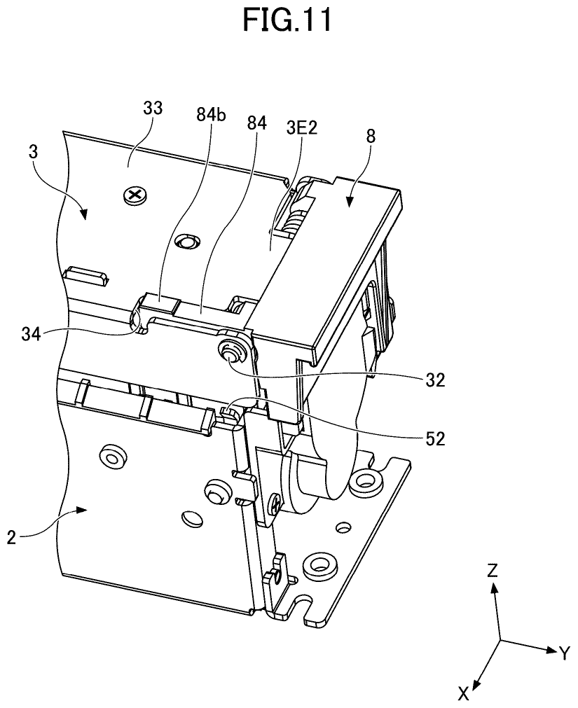

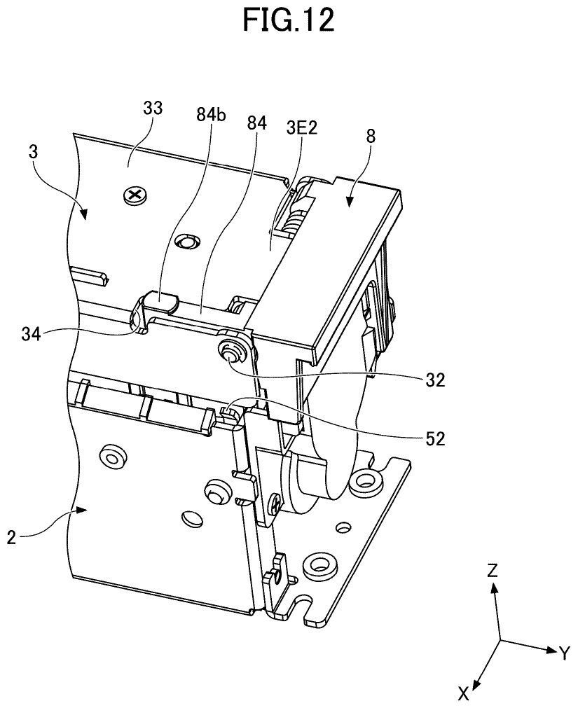

The printer 1 according to the present embodiment is not limited to the above-described configuration. Hereinafter, a modified example of the printer 1 according to the present embodiment will be described. FIG. 11 is a perspective view illustrating the main body 2 and the openable-closable section 3 in Modified Example 1 and FIG. 12 is a perspective view illustrating the main body 2 and the openable-closable section 3 in Modified Example 2, of the printer 1. In these modified examples, a projection 84b projecting from the end surface of the openable-closable section 3 on the side opposite to the main body 2 is provided at the tip of the lock release lever 84 of the opening-closing lever 8.

Specifically, in the example as illustrated in FIGS. 11 and 12, in the lock release lever 84 when the opening-closing lever 8 is in the lock position, only the projection 84b projects from the upper surface of the cover 33, which is the end surface of the openable-closable section 3 on the side opposite to the main body 2. The end surface of the lock release lever 84 on the side opposite to the main body 2, except for the projection 84b, is flush with the upper surface of the cover 33 without a step because the lock release lever 84 is accommodated in the notch 34 of the cover 33.

In the example as illustrated in FIG. 11, the shape of the projection 84b is rectangular when viewed from the direction perpendicular to the top surface of the cover 33. In the example as illustrated in FIG. 12, as viewed from the direction perpendicular to the upper surface of the cover 33, the projection 84b has an oval shape or a track shape having arcs at both ends of the projection 84b in the longitudinal direction of the lock release lever 84 and a straight portion between the arcs. However, the shape of the projection 84b is not particularly limited.

As described above, since the projection 84b projecting from the end surface of the openable-closable section 3 on the side opposite to the main body 2 is provided at the tip of the lock release lever 84, the user of the printer 1 can push the projection 84b to rotationally move the opening-closing lever 8 from the lock position to the release position. This makes it easy to rotationally move the opening-closing lever 8 to release the locked state of the openable-closable section 3 closingly fixed to the main body 2, and it can be visually understood by the user that the user can press the projection 84b to release the locked state of the openable-closable section 3. Moreover, since the portion other than the projection 84b does not protrude from the end surface of the openable-closable section 3 on the side opposite to the main body 2, it is possible to suppress the erroneous operation of the opening-closing lever 8 and to suppress the erroneous release of the locked state of the openable-closable section 3.

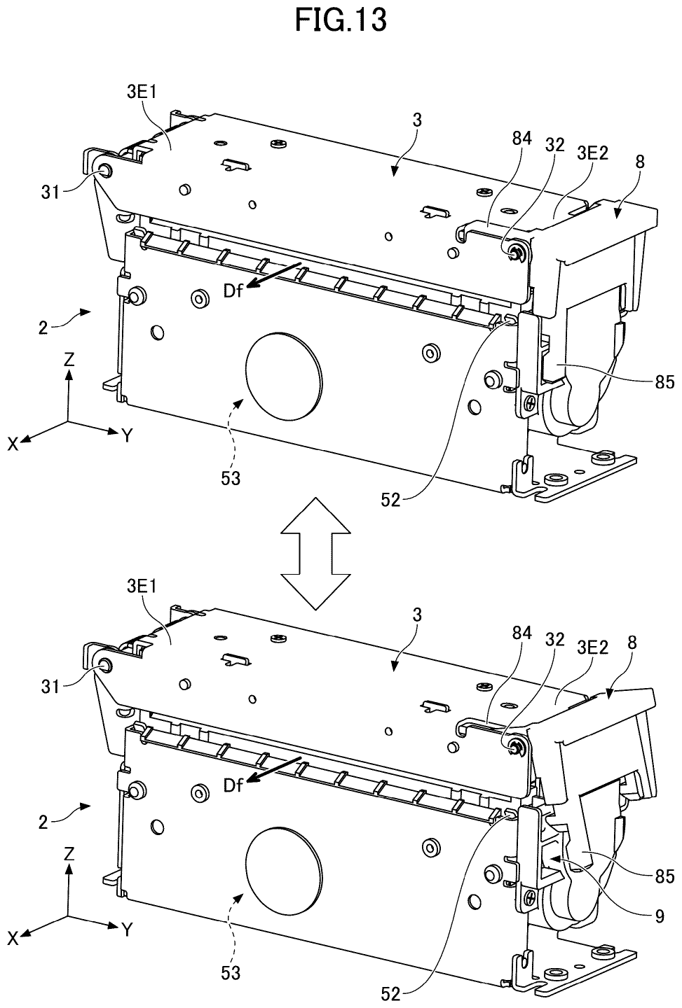

FIG. 13 is perspective views illustrating the main body 2 and the openable-closable section 3 in Modified Example 3 of the printer 1 of the present embodiment. In the printer 1 of the present embodiment, as illustrated in FIG. 6, the open-close sensor 9 is provided on the side of the main body 2 on the rear side of the conveying direction Df of the recording paper P, and as illustrated in FIG. 8, the opening-closing lever 8 includes an extended portion 85 on the rear side of the conveying direction Df of the recording paper P.

However, in the printer 1 of Modified Example 3 as illustrated in FIG. 13, the open-close sensor 9 and the extended portion 85 of the opening-closing lever 8 are provided on the side of the main body 2 on the front side of the conveying direction Df of the recording paper P. In the printer 1 of Modified Example 3, the same effect as in the printer 1 of the first embodiment can be achieved. That is, the positions of the open-close sensor 9 and the extended portion 85 of the opening-closing lever 8 are not particularly limited.

### Second Embodiment

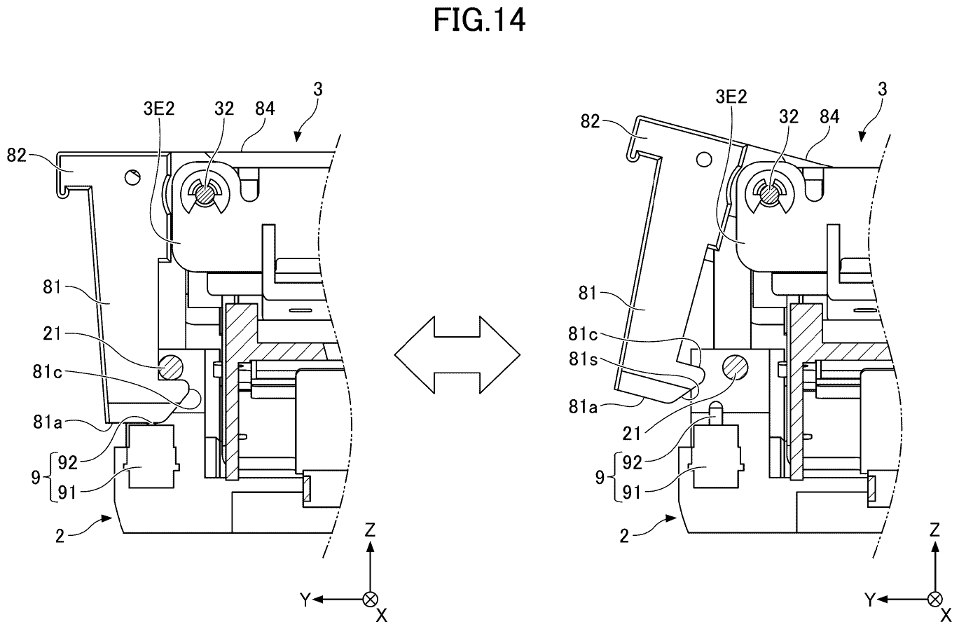

Next, a second embodiment of the printer according to the present disclosure will be described with reference to FIG. 14. FIG. 14 is enlarged cross-sectional views illustrating a part of the main body 2 and the openable-closable section 3 of the second embodiment of the printer according to the present disclosure.

The printer 1 of the present embodiment is different from the printer 1 of the aforementioned first embodiment in that the opening-closing lever 8 does not include the extended portion 85 and the plunger 92 of the open-close sensor 9 projects toward the upper surface of the main body 2 facing the openable-closable section 3 in the cutting direction Dc of the recording paper P. Since the other configuration of the printer 1 of the present embodiment is the same as that of the printer 1 of the first embodiment, similar components are denoted by the same reference numerals and descriptions thereof are omitted.

As illustrated in the left diagram of FIG. 14, in the printer 1 of the present embodiment, the opening-closing lever 8 includes the engagement portions 81 that extend along the side surface of the openable-closable section 3 and engage with the side surface of the main body 2 when the opening-closing lever 8 is in the lock position. The open-close sensor 9 detects that a tip surface 81a of the engagement portion 81 is in the lock position. Specifically, the plunger 92 of the open-close sensor 9 projects toward the tip surface 81a of the engagement portion 81 facing the direction opposite to the top surface of the openable-closable section 3, when the opening-closing lever 8 is in the lock position. Thus, the plunger 92 of the open-close sensor 9 is pushed away from the openable-closable section 3 of the recording paper P, in the cutting direction Dc, by the tip surface 81a of the engagement portion 81 when the opening-closing lever 8 is in the lock position as illustrated in the left diagram of FIG. 14.

As illustrated in the right diagram of FIG. 14, the open-close sensor 9 detects that the opening-closing lever 8 is not in the lock position, that is, in the release position, in the semi-locked state where the openable-closable section 3 is closed to the main body 2 and the engagement portions 81 of the opening-closing lever 8 are not engaged with the shaft portions 21 on the side of the main body 2.

In the semi-locked state as illustrated in the right diagram of FIG. 14, when the opening-closing lever 8 is rotationally moved to the lock position as illustrated in the left diagram of FIG. 14, an inclined surface 81s provided at the tip of the engagement portion 81 contacts the tip of the plunger 92 and pushes the plunger 92 into the main body 91. The inclined surface 81s at the tip of the engagement portion 81 is inclined from the tip of the hook 81c toward the tip surface 81a, as it approaches the tip surface 81a.

Then, when the opening-closing lever 8 is further rotationally moved to the lock position, the tip surface 81a of the engagement portion 81 contacts the tip of the plunger 92 and pushes the plunger 92 further into the main body 91. Then, when the opening-closing lever 8 is rotationally moved to the lock position as illustrated in the left diagram of FIG. 14, the hook 81c of the engagement portion 81 engages with the shaft portion 21, and when the plunger 92 is further pushed into the main body 91, the open-close sensor 9 detects that the opening-closing lever 8 is in the lock position.

Therefore, in the present embodiment, as in the first embodiment, it is possible to provide a printer 1 configured to detect the semi-locked state, in which the openable-closable section 3 connected to the main body 2 is closed to the main body 2 and the openable-closable section 3 is not fixed to the main body 2.

All examples and conditional language provided herein are intended for the purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention. For example, the open-close sensor is not limited to a sensor including a plunger, and a magnetic or optical open-close sensor may be used. The opening-closing lever need not include a lock release lever. When the lock release lever is not configured to separate a fixed blade from a movable blade in a direction opposite to a biasing direction of a biasing part, the lock release lever may be disposed at the rear end of the openable-closable section in a paper conveying direction.

What is claimed is:

1. A printer, comprising:
a printer section configured to print on recording paper;
a main body configured to support a first portion of the printer section;
an openable-closable section rotatably connected to the main body about a rotary shaft orthogonal to a width direction of the recording paper and configured to support a second portion of the printer section;
an opening-closing lever provided at a second end portion of the openable-closable section on a side opposite to a first end portion connected to the main body and configured to rotationally move between a release position, in which the openable-closable section can be opened and closed, and a lock position, in which the openable-closable section is closingly fixed to the main body; and
an open-close sensor provided at the main body and configured to detect that the opening-closing lever is in the lock position.

2. The printer according to claim 1, wherein
a plunger configured to detect that the opening-closing lever is in the lock position by being pushed in by the opening-closing lever in the lock position.

3. The printer according to claim 1, wherein
the opening-closing lever includes
an engagement portion that, when the opening closing lever is in the lock position, extends along a side surface of the openable-closable section and is configured to engage with a side portion of the main body; and
an extended portion that extends along the side surface of the openable-closable section to a position farther away from the openable-closable section as compared to the engagement portion, wherein
the open-close sensor is configured to detect that the opening-closing lever is in the lock position, according to a position of the side surface of the extended portion facing the main body.

4. The printer according to claim 1, wherein
the opening-closing lever includes an engagement portion that, when the opening closing lever is in the lock position, extends along the side surface of the openable-closable section and is configured to engage with a side portion of the main body, and
the open-close sensor is configured to detect that a tip surface of the engagement portion is in the lock position.

5. The printer according to claim 1, wherein
the opening-closing lever includes a lock release lever that, when the opening closing lever is in the lock position, extends toward the first end portion of the openable-closable section.

6. The printer according to claim 5, wherein
in the opening-closing lever, upon being in the lock position, at least a part of the lock release lever projects from an end surface of the openable-closable section on a side opposite to the main body.

7. The printer according to claim 5, wherein
a projection projecting from the end surface of the openable-closable section on the side opposite to the main body is provided at a tip of the lock release lever.

8. The printer according to claim 5, wherein
the lock release lever is disposed at a rear end of the openable-closable section in a conveying direction of the recording paper.

9. The printer according to claim 5, further comprising:
a cutter configured to cut recording paper, wherein
the cutter includes a fixed blade supported by the openable-closable section, a movable blade disposed adjacent to the fixed blade in the conveying direction of the recording paper and supported by the main body, and a biasing part configured to bias the fixed blade toward the movable blade, and
the lock release lever is disposed at a steady position farther on a biasing direction side of the biasing part relative to the fixed blade upon the opening-closing lever being in the lock position, and the lock release lever is disposed at a paper release position, in which the fixed blade is separated from the movable blade in a direction opposite to the biasing direction of the biasing part upon the opening-closing lever being in the release position.

10. A printer, comprising:
a printer section configured to print on recording paper;
a main body configured to support a first portion of the printer section;
an openable-closable section rotatably connected to the main body about a rotary shaft orthogonal to a width direction of the recording paper and configured to support a second portion of the printer section; and
an opening-closing lever provided at a second end portion of the openable-closable section on a side opposite to a first end portion connected to the main body and configured to rotationally move between a release position, in which the openable-closable section can be opened and closed, and a lock position, in which the openable-closable section is closingly fixed to the main body, wherein
the opening-closing lever includes
an engagement portion that, when the opening closing lever is in the lock position, extends along a side surface of the openable-closable section and is configured to engage with a side portion of the main body; and
a lock release lever that extends toward the first end portion of the openable-closable section upon the opening-closing lever being in the lock position.

11. The printer according to claim 10, wherein
the opening-closing lever is disposed at a rear end of the openable-closable section in a conveying direction of the recording paper.
